(19) United States
(12) Patent Application Publication
(10) Pub. No.: US 2016/0299498 A1
(43) Pub. Date: Oct. 13, 2016

(54) SYSTEM FOR NAVIGATING A FIELD OF VIEW OF A DISPLAYED AND MAGNIFIED SURFACE

(71) Applicant: NANOVEA, INC., Irvine, CA (US)

(72) Inventor: Fernando Valenzuela, Lake Forest, CA (US)

(21) Appl. No.: 14/683,977

(22) Filed: Apr. 10, 2015

(51) Int. Cl. G05B 19/418; H04N 5/232; H04N 7/18

(52) U.S. Cl. CPC G05B 19/4189; H04N 7/183; H04N 5/23293

(57) ABSTRACT

A camera enabled navigation system for a material testing apparatus, comprising: a camera; a movable stage; a display; an interface device; a processor; a data storage; and a sensor head. The movable stage may receive a sample, an image of which is captured by the camera to create a field of view. The navigation system allows for adjusting the field of view of the displayed and magnified surface of the sample. The navigation movements are smooth, intuitive, and take into consideration current magnification, maximum movement speed, cursor position. The system also allows the user to navigate a larger stitched image.

### FIELD OF USE

The present disclosure relates generally to devices and methods for instrument control via a camera-enabled user interface, wherein the speed of the movement of the video image relative to a testing sample is modified based on the magnification and viewable area.

### BACKGROUND

During indentation, wear, and scratch testing or taking profilometry measurements of a sample to be tested, the user often selects test locations on the sample. For example, the user may select a test location by choosing an area in relation to the center of the visualization of a microscope (i.e., viewable area). Alternatively, the user may click on various positions on one single live image to record the position as to where the measurements should be performed.

Unfortunately, it is often difficult and time consuming to navigate on the sample to find the correct test location. The user often uses high magnification levels, which typically results in slower movement and longer navigation time. This is especially true at higher magnification levels where the area displayed from a live-feed image is limited. On the other hand, if the user selects a faster speed, the user may incidentally pass over the desired position. Given that most sample testing under a microscope is generally keyboard or joystick based, this is also often quite cumbersome.

Additionally, the speed or movement is typically pre-selected and/or changed manually by the user. Specifically, once the speed of movement is selected, that speed is generally the same, and the user must manually change the desired speed after each time the magnification is changed. If the user selects an incorrect magnification or speed, then the movement may be either be too fast or too slow, making the selection of the position difficult. As such, speed must generally be adjusted, depending on where the user wants to go.

U.S. Pat. Nos. 7,146,372, 7,149,332, and 7,792,338, all of which are issued to James W. Bacus (collectively “Bacus”) disclose systems and methods for taking multiple images of samples at varying levels of magnification and marking specific locations in order to assist a user in navigating the sample view. The images are then assembled into a seamless virtual slide or specimen image. However, the Bacus references do not disclose methods for automatically controlling or adjusting the speed of movement of the view, or utilizing a navigation method associated with indenter testing.

U.S. Pat. No. 7,262,907 issued to Wolfgang Rentzsch (“Rentzsch) discloses the use of a computer mouse to navigate a view of a sample and allows the user to control the position of the specimen in the X-Y axis. Control signals are commanded by the operator, and, based on the relative motion between the microscope and the substrate, directional and position signals are generated with a motorized microscope stage in the X and/or Y direction. Importantly, the Rentzsch reference, like the Bacus references, does not disclose methods for controlling or adjusting the speed of movement of the view.

U.S. Pat. No. 7,139,422 issued to John Michael Hauck (“Hauck”) discloses an indentation test system that includes a movable stage, camera, processor, and display which is configured to create a composite image of a sample by moving the stage via a computer code. The executable code instructs the processor to: (1) capture a series of real-time images of the sample using the camera, (2) obtain associated stage coordinates for each of the images, and (3) display a composite image, which includes real-time images assembled according to the associated stage coordinates. However, the Hauck reference does not allow a user to control the speed of movement to move smoothly and efficiently to a desired specific location.

U.S. Pat. No. 7,173,637 issued to Kenneth Paul Hinckley (“Hinckley”) discloses a method for distance-based acceleration scrolling using a computer mouse. The system disclosed in the Hinckley reference accelerates scrolling based on the distance that a user has already scrolled, and continues to scroll in a quick manner. The system may then inhibit acceleration when the user slows down or reverses direction in order to return fine scrolling capabilities to the user. However, this acceleration method is controlled by the speed of the mouse movement and not by cursor position.

Accordingly, despite currently available methods, the process of identifying and navigating to a desired portion of a sample to perform a test with a material testing apparatus is unnecessarily time consuming and very cumbersome.

Thus, what is needed is a new and improved device, method, and/or system for navigating a viewable surface of a sample to be analyzed by a material testing apparatus. Preferably, the new and improved method is intuitive to use, has smooth movements, and allows for easier, faster, and more efficient selection of test positions on a large surface, even at high magnification.

### SUMMARY OF EMBODIMENTS

To minimize the limitations in the prior art, the present specification discloses a new and useful device, system, and method for controlling the relative movement of an instrument stage via a camera.

One embodiment may be a camera enabled navigation system for a material testing apparatus, comprising: a camera; a movable stage; a display; an interface device; a processor; and a data storage; wherein the movable stage is configured to receive a sample; wherein the camera comprises one or more lenses that are positioned approximately above the sample, such that the camera is configured to capture one or more images of the sample; wherein the processor is coupled to the camera and is operatively associated with the data storage, such that the processor is adapted to execute computer implemented instructions to: display on the display the one or more captured images transmitted from the camera; calculate one or more dimensions of a field of view that is displayed on the display; pre-store the one or more captured images into the data storage; receive one or more selected points of the displayed one or more captured images from the interface device based on one or more inputs of a user; record one or more coordinates based on the one or more selected points of the interface device; wherein the one or more coordinates are based on a distance from a center of the field of view to the one or selected points; calculate an image speed percentage based on the one or more coordinates; calculate a stage speed based on the one or more dimensions of the field of view; and actuate one or more motors of the movable stage based on the image speed percentage and the stage speed, such that a speed of an image movement is proportional to a distance between the one or more selected positions and the center of the field of view. The image speed percentage of the one or more coordinates may also be calculated based on one or more dimensions of the image. The calculating function of the one or more dimensions of the field of view may be based on a zoom range of the one or more camera lenses. The processor may be configured to create a mapping based on a plurality of mapping images by: calculating a second field of view based on the plurality of mapping images; recording one or more second coordinates of the plurality of mapping images; and calculating a plurality of stage positions based on the plurality of second coordinates, such that each of the plurality of stage positions corresponds with each of the plurality of mapping images. The plurality of stage positions may be calculated based on one or more dimensions of the plurality of mapping images. The plurality of stage positions may be calculated based on one or more offsets from a center of the second field of view. The processor may be further adapted to execute computer implemented instructions to limit an image size for each of the plurality of mapping images. The camera enabled navigation system may further comprise a sensor head; wherein the sensor head may determine a reference point within the field of view; and wherein the processor may be further adapted to calculate an offset between the sensor head and the camera lens, such that the processor may be adapted to calculate a position required to actuate the movable stage to the sensor head. The processor may be a computer system electrically coupled to a material testing apparatus; and wherein the computer system may be configured to execute the computer implemented instructions, such that the computer system actuates the movement of the movable stage. The interface device may be selected from the group of interface devices consisting of: a mouse and a touchscreen.

Another embodiment may be a camera enabled navigation system for a material testing apparatus, comprising: a camera; a movable stage; a display; an interface device; a processor; and a data storage; wherein the movable stage is configured to receive a sample; wherein the camera comprises one or more lenses that are positioned approximately above the sample, such that the camera is configured to capture one or more images of the sample; wherein the processor is coupled to the camera and is operatively associated with the data storage, such that the processor is adapted to execute computer implemented instructions to: display on the display the one or more images transmitted from the camera; capture the one or more images transmitted from the camera to the display, such that a field of view is displayed on the display; calculate one or more dimensions of the field of view that is displayed on the display; position a cursor of the interface device on the one or more displayed images; receive one or more selected points of the one or more displayed images from the interface device based on one or more positions of the cursor; record one or more coordinates based on the one or more selected points of the interface device; wherein the one or more coordinates is based on a distance from a center of the field of view to the one or selected points; calculate an image speed percentage based on the one or more coordinates; wherein the image speed percentage of the one or more coordinates is also calculated based on one or more dimensions of the one or more images; calculate a stage speed based on the one or more dimensions of the field of view; and actuate one or more motors of the movable stage based on the image speed percentage and the stage speed, such that a speed of an image movement is proportional to a distance between the cursor and the center of the field of view. The calculating function of the one or more dimensions of the field of view may be based on a zoom range of the one or more camera lenses. The processor may be adapted to create a mapping based on a plurality of mapped images by: calculating a second field of view based on the plurality of mapped images; recording one or more second coordinates of the plurality of mapped images; and calculating a plurality of stage positions based on the plurality of second coordinates, such that each of the plurality of stage positions corresponds with each of the plurality of mapped images. The plurality of stage positions may also be calculated based on one or more dimensions of the plurality of mapped images. The plurality of stage positions may also be calculated based on an offset from a center of the second field of view. The processor may be further adapted to execute computer implemented instructions to limit an image size for each of the plurality of mapped images. The camera enabled navigation system may further comprise a sensor head; wherein the sensor head may determine a reference point within the field of view; and wherein the processor may be further adapted to: calculate an offset between the sensor head and the one or more camera lenses, such that the processor is adapted to calculate a position required to actuate the movable stage to the sensor head; and positioning the one or more camera lenses from a center of the field of view to the sensor head. The processor may be a computer system electrically coupled to a material testing apparatus; and wherein the computer system may be configured to execute the computer implemented instructions, such that the computer system actuates the movement of the movable stage.

Another embodiment may be a camera enabled navigation system for a material testing apparatus, comprising: a camera; a movable stage; a display; an interface device; a processor; a data storage; and a sensor head; wherein the movable stage is configured to receive a sample; wherein the camera comprises one or more lenses that are positioned approximately above the sample, such that the camera is configured to capture an image of the sample; wherein the processor is coupled to the camera and is operatively associated with the data storage, such that the processor is adapted to execute computer implemented instructions to: display on the display the image transmitted from the camera; capture the image transmitted from the camera to the display, such that a field of view is displayed; calculate one or more dimensions of the field of view that is displayed on the display; wherein the calculating function of the one or more dimensions of the field of view is based on a zoom range of the camera lens; position a cursor of the interface device on the displayed image; receive one or more selected points of the displayed image from the interface device based on one or more positions of the cursor; record one or more coordinates based on the one or more selected points of the interface device; wherein the one or more coordinates is based on a distance from a center of the field of view to the one or selected points; calculate an image speed percentage based on the one or more coordinates; wherein the image speed percentage of the one or more coordinates is also calculated based on one or more dimensions of the image; calculate a stage speed based on the one or more dimensions of the field of view; and actuate a motor of the movable stage based on the image speed percentage and the stage speed, such that a speed of an image movement is proportional to a distance between the cursor and the center of the field of view; wherein the processor is adapted to create a mapping based on a plurality of mapped images by: calculating a second field of view based on the plurality of mapped images; limiting an image size for each of the plurality of mapped images; recording one or more second coordinates of the plurality of mapped images; and calculating a plurality of stage positions based on the plurality of second coordinates, one or more dimensions of the plurality of mapped images, and one or more offsets from a center of the second field of view, such that each of the plurality of stage positions corresponds with each of the plurality of mapped images; wherein the sensor head determines a reference point within the field of view; and wherein the processor is further adapted to: calculate an offset between the sensor head and the camera lens, such that the processor is adapted to calculate a position required to actuate the movable stage to the sensor head; and position the camera lens from a center of the field of view to the sensor head.

The navigation system allows for easy, intuitive, and efficient navigation with multiple objectives and zoom levels using a mouse position in relation to the live image on the screen. The navigation system may also allow the user to map a larger image area and select test positions on the mapped image.

It may be an object to provide a device, system, and computer-implemented method for adjusting a field of view of a displayed and magnified surface that provides smooth movement and may be intuitive.

It may be an object to provide a device, system, and computer- and/or camera-implemented method for adjusting a field of view of a displayed and magnified surface. Preferably, the device, system, and computer- and/or camera-implemented method will provide for easier and more efficient selection of test positions on a larger area, even at high magnification.

It may be another object to overcome the deficiencies of the prior art.

These, as well as other components, steps, features, objects, benefits, and advantages, will now become clear from a review of the following detailed description of illustrative embodiments, of the accompanying drawings, and of the claims.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of a perspective view of one embodiment of a material testing apparatus.

FIG. 2 is a block diagram of one embodiment of a computer system.

FIGS. 3A to 3C are illustrations representing the speed of the movement caused by the placement of cursor in relation to its position in the field of view of one embodiment of an apparatus for adjusting the field of view of a magnified sample.

FIG. 4 is an illustration showing the position of the cursor in relation to its position in the field of view according to another embodiment of an apparatus for adjusting the field of view of a magnified sample.

FIG. 5 is an illustration showing the position of the cursor in relation to its position in the field of view according to another embodiment of an apparatus for adjusting the field of view of a magnified sample.

FIG. 6 is an illustration showing the position of the cursor in relation to its position in the field of view according to another embodiment of an apparatus for adjusting the field of view of a magnified sample.

FIG. 7 is a screenshot of another embodiment of the display used in an apparatus for adjusting the field of view of a magnified sample.

FIG. 8 is a screenshot of another embodiment of the display used in an apparatus for adjusting the field of view of a magnified sample and shows multiple selected test start position on a mapped image.

FIG. 9 is a screenshot of one embodiment of the test window for inputting test parameters.

FIG. 10 is a screenshot of another embodiment of the display used in an apparatus for adjusting the field of view of a magnified sample and shows stage movement settings relating to the advanced movement button.

### DETAILED DESCRIPTION OF THE DRAWINGS

In the following detailed description, numerous specific details are set forth in order to provide a thorough understanding of various aspects of one or more embodiments. However, the one or more embodiments may be practiced without some or all of these specific details. In other instances, well-known procedures and/or components have not been described in detail so as not to unnecessarily obscure aspects of the embodiments.

While some embodiments are disclosed herein, still other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For example, as used herein, the terms “computer” or “computer system” generally refer to any device or machine that processes data or information (e.g., load data, Martens hardness data, load rate) with an integrated circuit chip, including without limitation, personal computers, mainframe computers, workstations, testing equipment, servers, desktop computers, portable computers, laptop computers, embedded computers, wireless devices including cellular phones, personal digital assistants, tablets, tablet computers, smartphones, portable game players, and hand-held computers.

As used herein, the term “navigation system” generally refers to a program, system, computer system, or device that is used to control a camera or a movable stage in order to find suitable testing location on a sample or material.

As used herein, the term “stitched image” refers to a mapped image that comprises one or more composite images that are joined together to create a larger image. When a sample is larger than a single field of view, the regions that are imaged under the microscope are generally combined to create a larger single image. Preferably, these blocks of images are combined without artifact due to image misalignment. For example, one embodiment of a system may utilize an accurate x-y movable stage to produce images at precise positions by abutting the images into a seamless, well registered set of images. Another embodiment may utilize one or more software algorithms to determine the optimal registration for a set of images. These stitching algorithms preferably capture a number of images and attempt to optimally position these blocks of images into a seamless well-formed image.

As used herein, the terms “camera” and “video camera” refer to a device for capturing and/or transmitting in a streaming manner one or more images, including cameras, analog cameras, video cameras, digital cameras, digital video capture, and digital video cameras.

As used herein, the term “interface device” refers to a mouse, touchpad, touchscreen, joystick, trackball, keyboard, and the like.

As used herein, the term “data storage device” refers to any device or component used to store data or information. Examples of such include, without limitation, a computer-readable medium device such as floppy disk, magnetic hard disk drive, universal serial bus (USB) thumb drive, and solid state hard disk, memory such as flash memory, random access memory (RAM), memory, read-only memory (ROM), optical disk, magneto-optical disk, and register files of a processor.

As used herein, the terms “approximately” and “about” generally refer to a deviance of within 5% of the indicated number or range of numbers. In one embodiment, the term “approximately” and “about”, refer to a deviance of between 1-10% from the indicated number or range of numbers.

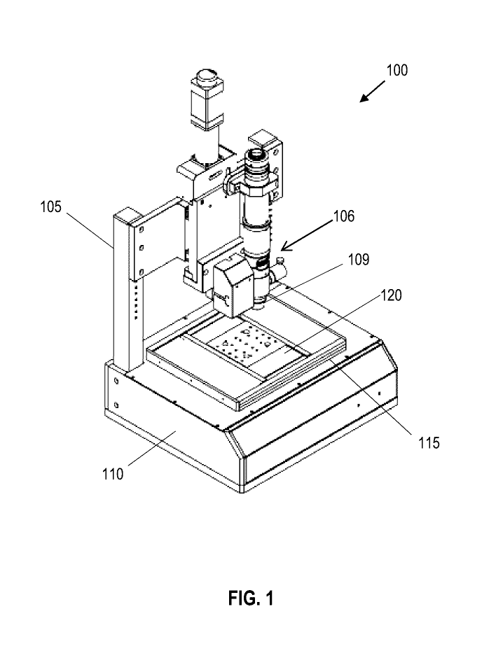

FIG. 1 is an illustration of a perspective view of one embodiment of a material testing apparatus. As shown in FIG. 1, one embodiment of the material testing apparatus 100 may comprise: a frame 105, base 110, a table 115, and a stage 120. The stage 120 may preferably be a movable stage. The frame 105 is generally any structural support (e.g., mounting frame) that may be used to house and protect the inner components of the material testing apparatus 100. The base 110 is generally any structural support that provides mounting for the frame 105 and main components of the material testing apparatus 100. The table 115 or stage may be any component used to help hold, position, and/or secure a sample or specimen for indentation testing. The sample may be secured on the table 115 and/or movable stage 120 via fasteners such as clamps or brackets, and the movable stage 120 may be moved along an axis or grid for positioning the sample. The material testing apparatus 100 may be any type of indenting-type testing apparatus such as hardness indenter tester, wear tester, and/or scratch tester.

The frame 105 may comprise an indenter module assembly 106, which, in turn, may comprise a force transducer, displacement sensor, indenter, and camera(s) 109. The camera 109 may be a digital or analog camera that may be coupled to a microscope for magnification abilities. In another embodiment, the camera 109 may comprise lenses and/or zoom lenses for magnification abilities. The zoom lens may have stages or set magnification positions, or the magnification of the zoom lenses may be variable and fluid. In various embodiments, either the stage 120 or the camera 109—or both—may be move along an X-Y grid, such that the camera 109 can be used to navigate samples on the stage in order to select and locate suitable sample testing locations.

In various embodiments, the force transducer, displacement sensor, indenter, and camera 109 may be housed altogether. In other embodiments, the force transducer, displacement sensor, and indenter may be separated in other areas of the material testing apparatus 100. The force transducer generally provides precision measuring of a load applied onto a surface of the sample and may be configured to be used in a wide variety of loads. In one embodiment, the force transducer may be a load cell, which comprises an ultra-low capacity load cell and bracket. The indenter is preferably configured to apply a load onto the surface of a sample, and may be coupled to the force transducer, such that the indenter is positioned above the top surface of the sample. The displacement sensor may be mounted within the indenter module assembly 106, table 115, stage 120, or within the frame 105, and is preferably configured to measure displacement of the indenter carried by the indenter module assembly 106, relative to the surface of the sample. In one embodiment, the displacement sensor may comprise capacitor rings that measure the vertical displacement of the shaft or indenter. Specifically, the displacement sensor may comprise two rings, one of which is attached to the moving frame and the other attached to the shaft holding the indenter. As the shaft moves in relation to the frame, the variation of the distance between the two rings or plates provides depth displacement.

In an alternative embodiment, the displacement sensor may comprise axial chromatism sensors, wherein the sensor measures the variation of wavelength between the emitted and received light by the emitter to calculate the penetration depth of the indenter. For example, in Axial Chromatism technology, height may be measured directly from the detection of the wavelength that hits the surface of the sample in focus. A white light sensor may be used to split the light into various wavelengths in the vertical direction, wherein each wavelength is associated with a specific displacement calibration. When a particular wavelength is in focus on the surface of the sample, that wavelength is preferably reflected with the highest intensity, and the corresponding depth change may be recorded accurately.

In another embodiment, the displacement sensor may comprise a linear variable differential transformer (LVDT), which is an electro-mechanical transducer used to measure position or displacement. The LVDT is preferably coupled mechanically into the material testing apparatus 100 and may provide a corresponding electrical signal or feedback signal relating to the physical position of the indenter.

In another embodiment, the displacement sensor may comprise a linear encoder, which may be a sensor or transducer paired with a scale that encodes position. The sensor may read the scale in order to convert the encoded position into an analog or digital signal, and that signal can then be decoded into position by a digital readout or motion controller.

In various embodiments, the indenter module assembly 106 may also comprise an actuator or driving mechanism, which may be any device that converts input signals into physical motion, including without limitation, piezoelectric elements (e.g., piezo activated flexures, piezo stacks, piezo tubes), linear motors, electrostatic motors, force coils, bimorphs, blocks, capacitive motors, voice coil actuators, and magnetostrictive actuators. In one embodiment, the actuator or driving mechanism may comprise, for instance, a piezoelectric element or force coil to drive the indenter into the surface of the sample. In other embodiments, the material testing apparatus 100 may instead comprise a servo or linear motor, which may be used for accurately applying load and controlling the applied load against a sample. Reduction gears may also be implemented to reduce the speed of the indenter by minimizing the power transferred to the indenter.

Regarding movement of the camera, one embodiment of the camera 260 may be positioned at a fixed point relative to the sensor head 260 of the material testing apparatus. However, in other embodiments, the camera 109 may be attached to a motor 265 or manual stage, such that that the camera 109 may move or shift along an axis such as the z-axis.

Regarding movement of the camera, a preferred embodiment of the stage may be an x-y motor stack with the motors being either a lead screw stage design with servo motors or stepper motors. However, in other embodiments, the stage may be a linear stage with a magnetic drive, where the linear stage is restricted to movement to a single axis of motion.

When in use, the material testing apparatus 100 may be configured to receive a sample for indentation testing. A sample may be loaded onto the stage 120 or table 115, and an indenter 109 is generally pressed onto the surface of the sample. The indenter module assembly 106 generally applies a load to the sample through the indenter, and the displacement sensor may measure the penetration depth of the indenter. The displacement sensor may, for example, measure the vertical displacement of the tip of the indenter, and thus, acquire penetration depth measurements of the sample. The force transducer may also monitor and measure the loading rate of the applied loads F used against the indenter and sample. While performing the indentation tests, the material testing apparatus 100 may record the load data, which may comprise applied load data, loading rate data, and depth data. In various embodiments, the material testing apparatus 100 may have an intrinsic compliance measures that are taken in account in a software application to provide an adjusted depth.

In another embodiment, the material testing apparatus may be configured as a profiler used for measuring a slope or a surface roughness of a material. In that embodiment, the sensor head may be an axial chromatism sensor as described above and may comprise a stage configured to move under the sensor in a rectangular pattern or raster scan pattern. The sensor may record depth information at each position, and the end result may be a three-dimensional (3D) model that may be analyzed. Analysis of the model may vary from step height measurements to roughness to flatness measurements. In various embodiments, the navigation system disclosed herein allows the user to either select the start position of the scan or a point that may be the center of the scanned area.

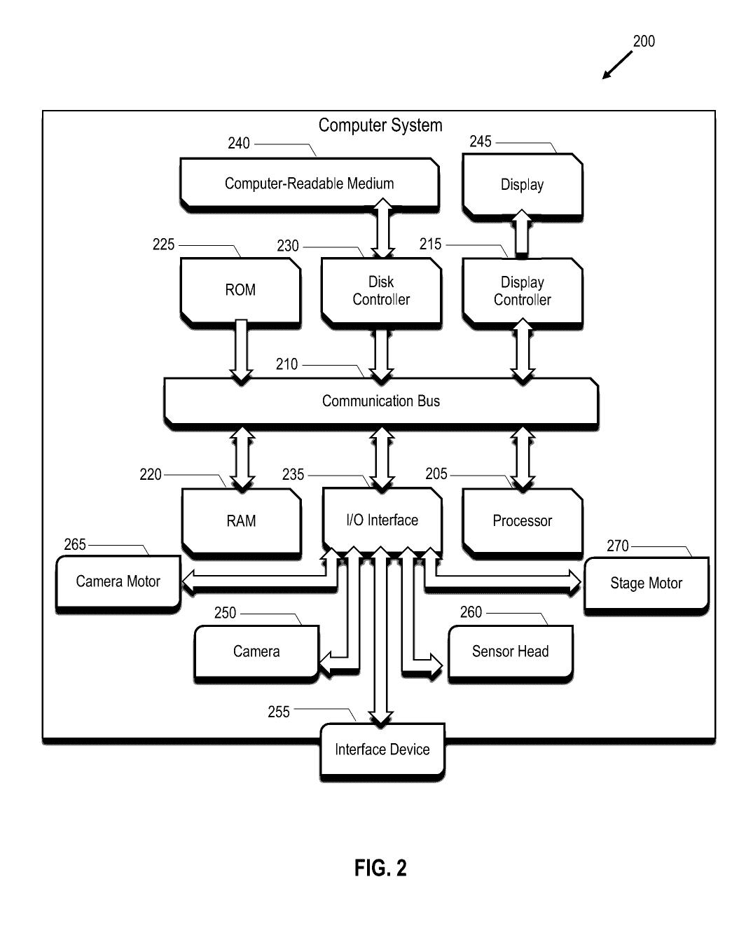

FIG. 2 is a block diagram of one embodiment of a computer system. The computer system may comprise a navigation system for a material testing apparatus. As shown in FIG. 2, one embodiment of the computer system 200 may comprise: a processor 205, communication bus 210, display controller 215, random access memory (RAM) 220, read only memory (ROM) 225, disk controller 230, input/output interface (I/O interface) 235, computer-readable medium 240, display 245, and one or more interface devices; wherein the one or more interface devices may be: a keyboard, pointing device (e.g., mouse), and/or a touchscreen. In one embodiment, the computer system 200 may be an integral part of the material testing apparatus 100. In another embodiment, the computer system 200 may be an independent computer electrically coupled to the material testing apparatus 100. The computer system 200 may comprise the processor 205 connected through a communication bus 210, wherein the communication bus 210 may further connect to other electronic hardware, including without limitation, a display controller 215, RAM 220, ROM 225, disk controller 230, and I/O interface 235. The disk controller 230 may be configured to control the computer-readable medium 240, which may be a hard drive and/or optical disk drive. The computer-readable medium 240 may also be another form of random access memory or flash memory. The display controller 215 may be connected to a display 245 such as a liquid crystal display (LCD), projection system, or touchscreen. The I/O interface 235 may be connected to one or more input devices such as an interface device 255 (e.g., mouse, keyboard, pointing device, touchscreen), camera 250, and sensor head 260. The camera 250 may be any component or electronic device capable of capturing one or more images and/or videos onto an electronic memory component. The sensor head 260 may be any component or device that detects, measures, and/or determines a physical property of the sample and may include, without limitation, indenters and profilometers. In additional embodiments, the computer system 200 may also comprise a network controller card connected through a network, such as the Internet or along an Intranet.

The processor 205 may be configured to execute a set of computer readable instructions and further to execute a software program, application or computer implemented instructions described herein. The computer readable instructions and application may comprise instructions that cause the processor 205 to perform one or more processes when the instructions are executed by the processor 205. In other various embodiments, the computer readable instructions or application may be tangibly embodied in the memory of the computer system 200 such as the RAM 220 or ROM 225, as shown in FIG. 2, or on a computer-readable storage medium, such as a magnetic, optical or solid-state digital storage medium.

In various embodiments, the computer system 200 may also be coupled to or be an integral part of the material testing apparatus 100. This computer system 200 may control testing and acquire test data and navigational data of the material testing apparatus 100. In some embodiments, the material testing apparatus 100 and/or the computer system 200 may comprise one or more motors 265, 270 that control either movement of the movable stage 120, movement of the camera 109, or both. In other embodiments, the computer system 200 may also comprise an interface unit coupled between the computer system and material testing apparatus 100 for converting electrical signals between the material testing apparatus 100 and the computer system 200.

When performing navigation on the surface of the sample, the material testing apparatus 100 and/or computer system 200 may be configured to receive a sample for material testing. A sample may be loaded onto the movable stage 120 or table 115, preferably below the camera 250. The camera 109 may then be used to create a field of view on the display 240 that may be connected to or integrated with the computer system 200 and/or the material testing apparatus 100. The computer system 200 may then be used to navigate a sample to be tested in order to find suitable testing locations.

In one embodiment, the computer system 200 may display a live image feed. In other embodiments, the computer system 200 may display a recorded/captured image(s), which may be a stitch image that is larger than a typical navigable video image. In a preferred embodiment, the computer system 200 may display an image that is based on an X-Y grid, where the speed of navigational movement is preferably proportional to the distance between the mouse pointer/selected point and the edge of visual image. Specifically, the maximum speed possible of navigational movement of the image may be adjusted based on: (1) the field of view of the camera 250, (2) magnification or zoom, (3) size or dimension of the image displayed, (4) maximum speed of the movable stage, (5) offset between the sensor head 260 and camera 250, and coordinates of the mouse pointer/selected point(s) in relation to the image on the display 245. Once the computer system 200 is configured to allow a user to select one or more testing positions or selected points, each selected point may be saved with that position's image, coordinates, offset, and/or list of test parameters, including, but not limited to, a test matrix and other tests parameters. Thus, after the selection, the computer system 200 and material testing apparatus 100 may be used to perform navigation and/or one or more tests according to selected positions and desired parameters saved. Preferably, the navigation of the camera across the surface of the sample is smooth and provides intuitive movements that allows the user to perform easier selection of test positions even at higher magnification. Preferably, the field of view is also determined for each zoom or magnification level, so that this information may be relayed to the processor 205 of the computer system 200.

After a material or sample to be tested is loaded onto the movable stage 120, the camera may produce a live image of the sample on the display 245. In a preferred embodiment, the processor 205 of the computer system 200 may acquire and/or calculate: (1) the dimensions of one or more field of views of the camera 250; (2) the size of the image displayed in dimensions or pixels; (3) the maximum speed of the navigational movement of the movable stage; (4) the position of the cursor or selected point on the image; (5) the offset or distance between the sensor head and the center of the camera; and (6) the coordinates of the mouse point/selected coordinates in relation to the image on the display 245. The user may use a mouse to position the cursor on the image at a desired location or choose one or more selected points in order to cause the navigation system to move the camera 250 and/or stage 120. When the mouse button is pressed, the coordinates in relation to the live camera image may be recorded, captured, and/or updated as the mouse cursor moves along the displayed image. A percentage or image speed percentage in relation to the center of the field of view may then be calculated by the processor 205 via the following formula or logic:

percentX=(mouseX−(imageWidth/2))/(imageWidth/2)

percentY=(mouseY−(imageHight/2))/(imageHeight/2)

wherein:

percentX is a proportional value of the center of the image of view on an X-axis;

percentY is a proportional value of the center of the image of view on the Y-axis;

mouseX is the cursor coordinates in relation to the displayed image on the X-axis;

mouseY is the cursor coordinates in relation to the displayed image on the Y-axis;

imageWidth is the width dimension of the image in pixels; and

imageHeight are the dimension of the image in pixels.

The computer system 200 may then set a speed at which the stage 120 and/or camera 210 moves. The maximum stage speed per field of view may be calculated by the following formula or logic:

stageSpeedX(mm/s)=fovWidth(mm)/timeFactor(s);

If stageSpeedX is greater than maxStageSpeedX, stageSpeedX=maxStageSpeedX;

stageSpeedY(mm/s)=fovHeight(mm)/timeFactor(s);

if stageSpeedY is greater than maxStageSpeedY, stageSpeedY=maxStageSpeedY; wherein:

stageSpeedX is the speed of the stage along the X-axis;

stageSpeedY is the speed of the stage along the Y-axis;

fovWidth is the horizontal dimension of the field of view of the camera;

fovHeight is the vertical dimension of the field of view of the camera;

maxStageSpeedX is the top speed of the stage along the X-axis;

maxStageSpeedY is the top speed of the stage along Y axis;

timeFactor is preferably the amount of time it may take to completely move out of the current field of view;

In various embodiments, the values of the fovWidth and fovHeight may be updated depending on the objectives or zoom lens magnification. Additionally, the timeFactor may be a constant for all fields of view and may be set according to the user's preference. This may allow the display 245 of the computer system 200 to provide a smooth consistent feel when switching objectives or magnification/zoom levels.

For a certain field of view at any position of the live image, the processor 205 may then send a command (e.g., a jog command) to actuate the motors 265, 270 of the camera or stage. The speed of the stage may then be determined by the following formula or logic:

For speed along the X axis=percentX*stageSpeedX; and

For speed along the Y axis=percentY*stageSpeedY.

Although the above embodiment is directed to a computer system 200 wherein the stage 120 moves, it should be understood that camera 210 instead of the stage 120 may move (or both). Also in various embodiments, for a microscope system, the field of view may be associated to a specific objective and the navigation system can access the different objective via a menu.

In another embodiment, the computer system 200 may create a mapped or a stitched image wherein the user inputs a number of images along x (e.g., images along the x-axis) and number of images in y (e.g., images along the y-axis) to stitch the images together. To create the mapped or stitched image, the computer system 200 may first calculate a second or new field of view of the mapped image using the following formula or logic:

newFOVWidth=x*fovWidth; and

newFOVHeight=y*fovHeight

wherein:

newFOVWidth is the horizontal dimension of the field of view of the stitched image;

newFOVHeight is the vertical dimension of the field of view of the stitched image;

x is the number of stitched images along the x-axis;

Y is the number of stitched images along the y-axis;

fovWidth is the horizontal dimension of the field of view of the camera; and

fovHeight is the vertical dimension of the field of view of the camera;

To save memory, the processor 205 may limit the size or dimensions of the stitched images to have a capped pixel size, so that each image that is stitched together is scaled accordingly. Once the images are stitched together, the resulting mapped image may have a size referred to as newImageSizeX & newImageSizeY.

At time of mapping, the position of the stage may then be recorded and may be used as a reference for the stitched image. With position of the stage and the field of view, the processor 205 may then be able to convert any position or coordinate on the stitched image with a stage position using the following formula or logic:

stagePositionX=((pixelX−(imageWidth/2))*mmPerPixX)+centerOffsetMMX;

stagePositionY=((pixelY−(imageHeight/2))*mmPerPixY)+centerOffsetMMY;

wherein:

pixelX is the pixel coordinates of the image along the X-axis;

pixelY are the pixel coordinates of the image along the Y-axis;

imageWidth is the horizontal dimensions of the image size in pixels;

imageHeight is the vertical dimensions of the image size in pixels;

mmPerPixX is calculated by dividing the newFOVWidth by imageWidth;

mmPerPixY is calculated by dividing the newFOVHeight by imageHeight;

centerOffsetMMX is the reference position in stage coordinate units along the X-axis; and

centerOffsetMMY is the reference position in stage coordinate units along the Y-axis.

Using the formula above in combination with the offset between the camera and the sensor head, the computer system 200 may calculate the position required to move the stage 120 or camera 250 in order to get to any given point or selected point on the mapped image, and thus to any point on the material to be tested. Thus, in various embodiments, the user may then: (1) select a point of the mapped image, (2) associate the point of the map image to a set of test parameters; and (3) then later perform one or more specific test at that position, according to specific test parameters. Thus, in these embodiments, the user may use the computer system 200 to select multiple points on the mapped image and set tests parameters for each position on the mapped image.

In another embodiment, instead of using a mouse or cursor device as the interface device 255, the user may use a touch screen and point directly on the screen to choose selected points and directly set one or more locations to be tested. In other embodiments, the user may also use a touch screen to control the cursor and/or the movement of the computer system 200.

In various alternative embodiments, rather having the stage 120 and sample move under the camera 210, the stage 120 and sample may remain stationary, and the computer system 200 may move the camera 210 and/or sensor head 260. Data on the field of view may then be loaded into the computer system 200 via a manually controlled or automated turret/zoom lens. In another embodiment, the live feed of the camera image may be sent directly to a remote computer, and the movement commands of the stage can be sent from the remote computer to the computer system 200 controlling the movement of the stage. Still, in other embodiments, the camera may be exchanged with any vision technology (USB, coax, thermal) as long as there is a way for the computer system 200 to access the relayed image. In various embodiments, the magnification or zoom function may be digital, which may allow the user to zoom in digitally for precise location on a mapped image. Still, in an alternative embodiment, the speed of the movement of the live image may to take in account both for optical zoom and a digital zoom lens. In another alternative embodiment, the material testing apparatus may comprise without a sensor head, which would be an embodiment used generally in microscopy, rather than material testing, to better navigate a sample being viewed. In another embodiment, rather than a live image feed, the computer system 200 can be used to navigate a captured image.

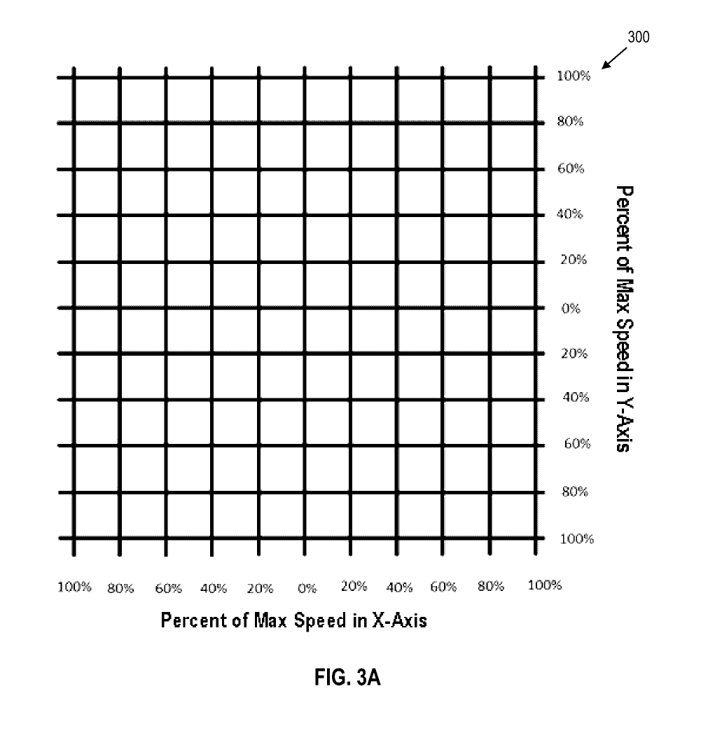

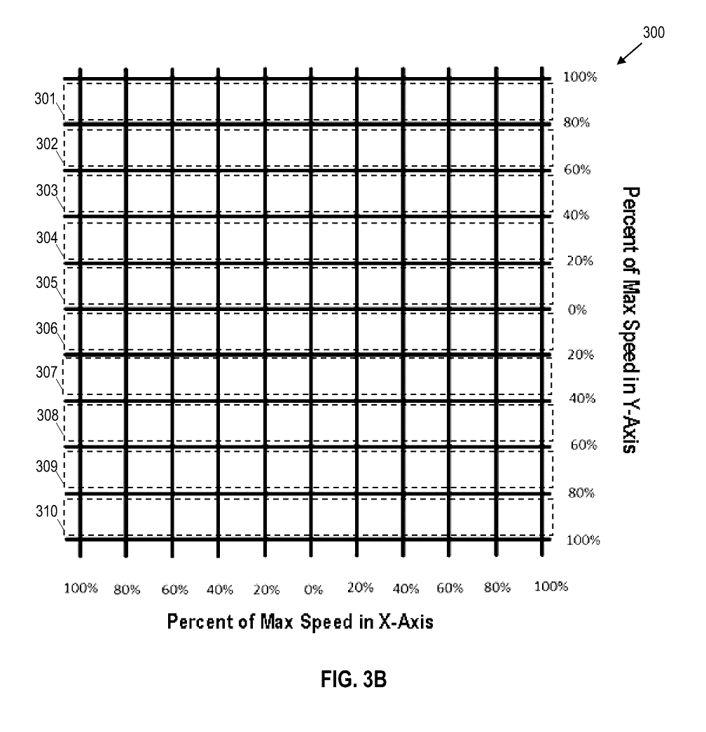

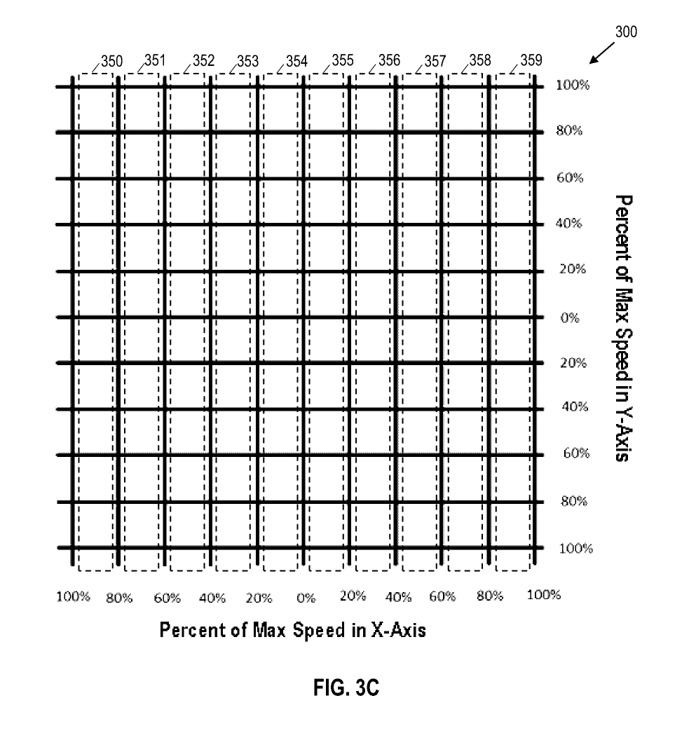

FIGS. 3A to 3C are illustrations representing the speed of the cursor in relation to its position in the field of view of one embodiment of an apparatus for adjusting the field of view of a magnified sample. As shown in FIGS. 3A to 3C, one embodiment of the device, system, and method 300, may comprise y-positions 301, 302, 303, 304, 305, 306, 307, 308, 309, 310 and x-positions 350, 351, 352, 353, 354, 355, 356, 357, 358, 359. FIG. 3B shows that as the cursor moves towards the edge of the grid vertically and away from the center, the speed of the movement of the displayed images changes. For example, as the cursor moves from the center of the grid 305, 306 and at a large distance towards the top edge of the grid at position 301, the speed of movement may increase substantially to approximately between 80 to 100%. Similarly, if the cursor moves from the center of the grid 305, 306 and at a large distance towards the bottom edge of the grid at position 310, the speed of movement may also increase to approximately between 80 to 100%.

On the other hand, as the cursor moves from the center of the grid 305, 306 and at a minimal distance towards the top edge of the grid at position 304, the speed of movement may increase slightly to approximately between 20 to 40%. Similarly, if the cursor moves from the center of the grid 305, 306 and at a minimal distance towards the bottom edge of the grid at position 307, the speed of movement may also increase slightly to approximately between 20 to 40%.

FIG. 3C shows that as the cursor moves towards the edge of the grid horizontally and away from the center, the speed of the movement of the displayed images changes. For example, as the cursor moves from the center of the grid 354, 355 and at a large distance towards the right side of the grid at position 359, the speed of movement may increase substantially to approximately between 80 to 100%. Similarly, if the cursor moves from the center of the grid 354, 355 and at a large distance towards the left side of the grid at position 350, the speed of movement may also increase substantially to approximately between 80 to 100%.

On the other hand, as the cursor moves from the center of the grid 354, 355 and at a minimal distance towards the right side of the grid at position 356, the speed of movement may increase slightly to approximately between 20 to 40%. Similarly, if the cursor moves from the center of the grid 354, 355 and at a minimal distance towards the left side of the grid at position 353, the speed of movement may also increase slightly to approximately between 20 to 40%.

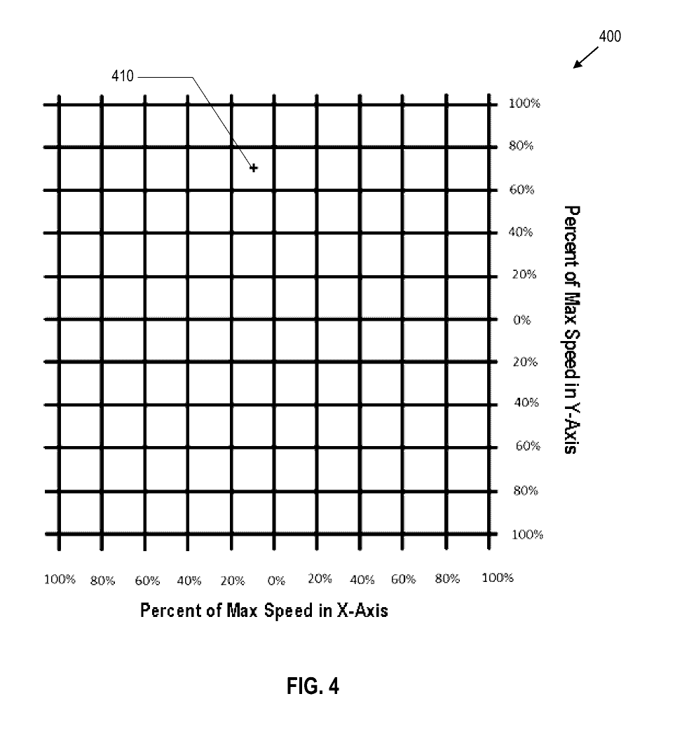

FIG. 4 is an illustration showing the position of the cursor in relation to its position in the field of view according to another embodiment of an apparatus for adjusting the field of view of a magnified sample. As shown in FIG. 4, one embodiment may comprise a cursor position 410. FIG. 4 shows that cursor position 410 may adjust the speed of movement to increase upwards vertically to approximately between 60 to 80% and horizontally left to approximately between 0 to 20%. To start the movement of the camera or stage to move in the direction and speed indicated by cursor position 410, the user would click on the mouse, or touch the touch screen.

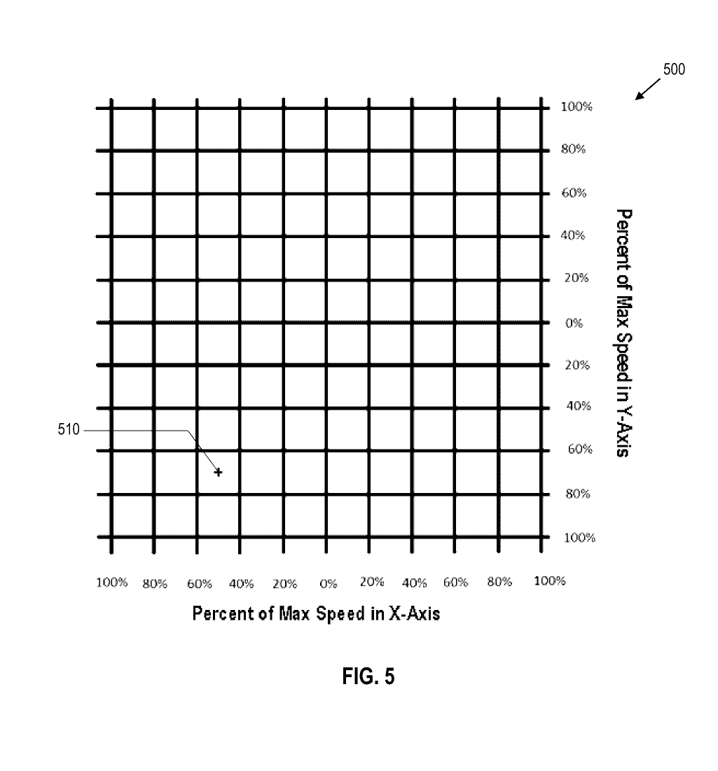

FIG. 5 is an illustration showing the position of the cursor in relation to its position in the field of view according to another embodiment of an apparatus for adjusting the field of view of a magnified sample. As shown in FIG. 5, one embodiment may comprise a cursor position 510. FIG. 4 shows that cursor position 510 may adjust the speed of movement to increase downwards vertically to approximately between 60 to 80% and horizontally left to approximately between 40 to 60%.

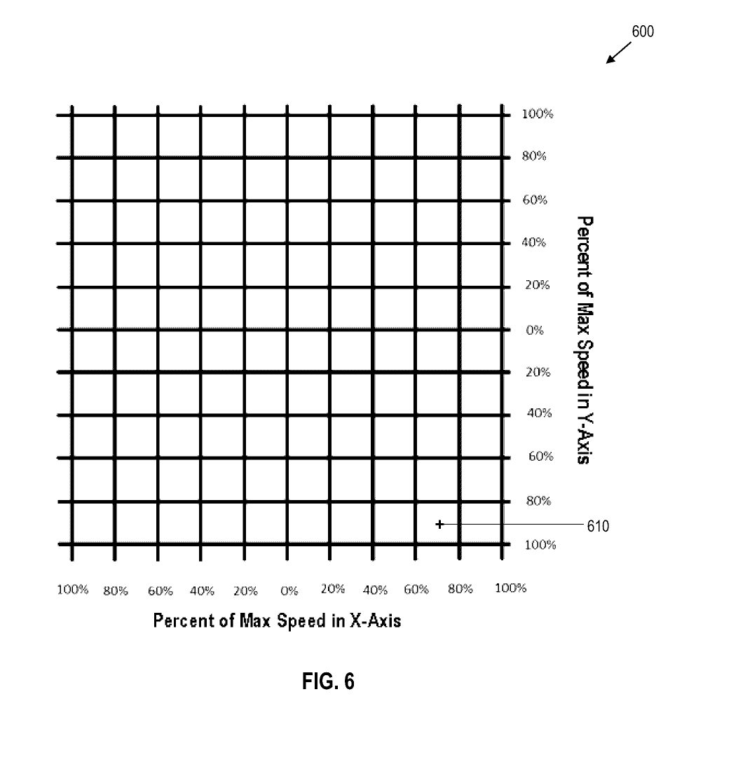

FIG. 6 is an illustration showing the position of the cursor in relation to its position in the field of view according to another embodiment of an apparatus for adjusting the field of view of a magnified sample. As shown in FIG. 6, one embodiment may comprise a cursor position 610. FIG. 4 shows that cursor position 610 may adjust the speed of movement to increase downwards vertically to approximately between 80 to 100% and horizontally right to approximately between 60 to 80%.

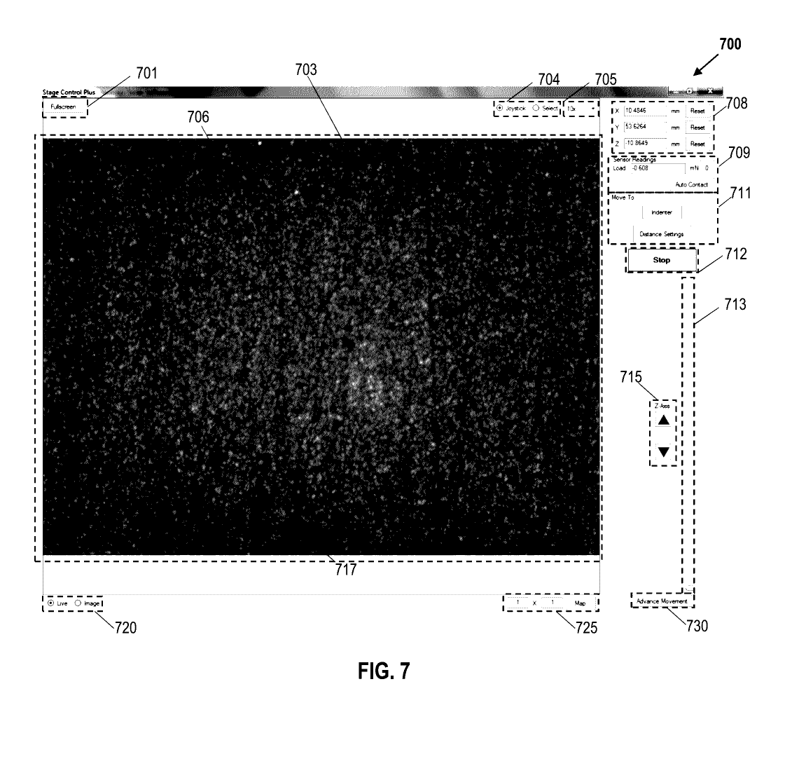

FIG. 7 is a screenshot of another embodiment of the display used in an apparatus for adjusting the field of view of a magnified sample. As shown in FIG. 7, one embodiment of the display 700 may comprise: a full screen button 701, test sample window 703, interface device parameter 704, magnification parameter 705, crosshair 706, view parameters 708, sensor readings 709, indenter and distance markers 711, stop button 712, z stage speed setting 713, Z-axis scroll tab 715, horizontal viewable distance 717, camera setting parameter 720, mapping parameter 725, and advanced movement button 730. The full screen button 701 preferably allows the user to minimize or maximize the test sample window 703 when viewing the surface of a sample. The interface device parameter 704 preferably allow the user to select the type of interface device (e.g., joystick, mouse cursor, touch screen) when viewing the sample through the camera. For example, the user may utilize an interface device, such as a joystick to navigate across the surface of the sample and/or may utilize an interface device, such as a mouse cursor to select certain areas of the sample for viewing. The magnification parameter 705 may allow the user to zoom or magnify the surface of the current image. The crosshair 706 preferably will allow the user to determine where the center of the map or sample is when observing the sample. The view parameters 708 may allow the user to modify the position of the camera by adjusting the vertical position (y-position), horizontal position (x-position), and distance between the viewing camera and the sample (z-position). The sensor readings 709 may provide the user with the amount of applied load applied to the sample. The indenter and distance markers 711 may allow the user to move the camera or stage automatically to the indenter or to a desired distance. The stop button 712 may halt the movement of the camera or stage, depending on which or both are movable. The z stage speed setting 713 and Z-axis scroll tab 715 may allow the user to adjust or control the distance between the sensor head and sample. In other embodiments, where the camera is connected to the same stage, the z stage speed setting 713 and Z-axis scroll tab 715 may allow the user to adjust the distance between the camera and the sample.

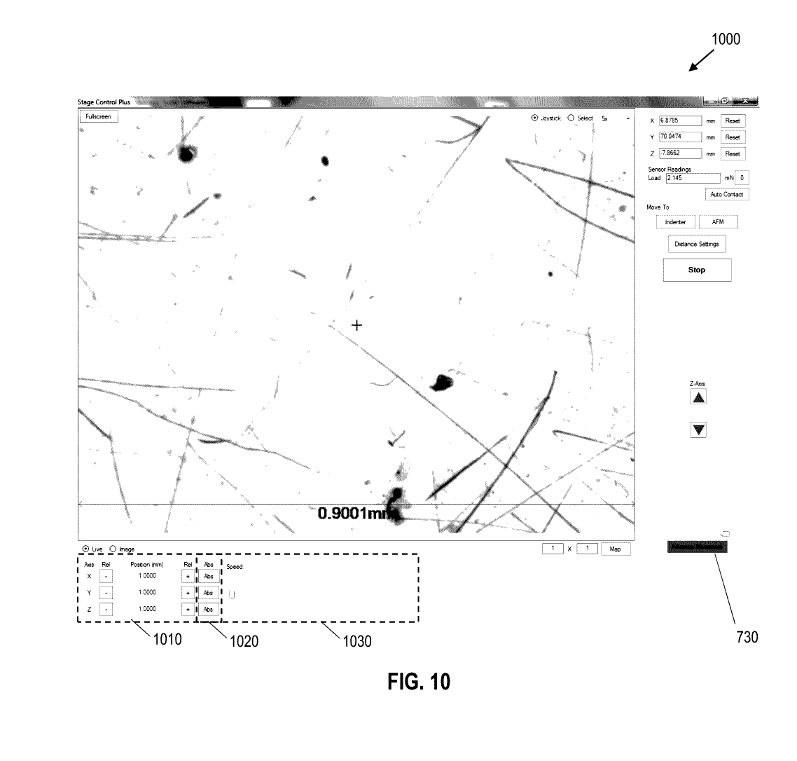

The horizontal viewable distance 717 may provide the user with the amount of horizontal viewable distance of the sample. The camera setting parameter 720 may allow the user to view the image from a live feed from the camera or from an image saved from the material testing apparatus. The mapping parameter 725 allows the user to select a number of images to use for the image mapping feature. The advance movement button 730 may provide additional or advance settings for navigating and viewing the camera across the sample. Specifically, the advance movement button 730 may provide additional settings for stage movement, such as: (1) providing precise incremental movements of the stage along an x- or y-axis; (2) providing an absolute stage position; and/or (3) adjusting the speed movement of the stage. One embodiment of the settings of stage movement from the advance movement button 730 is shown in FIG. 10.

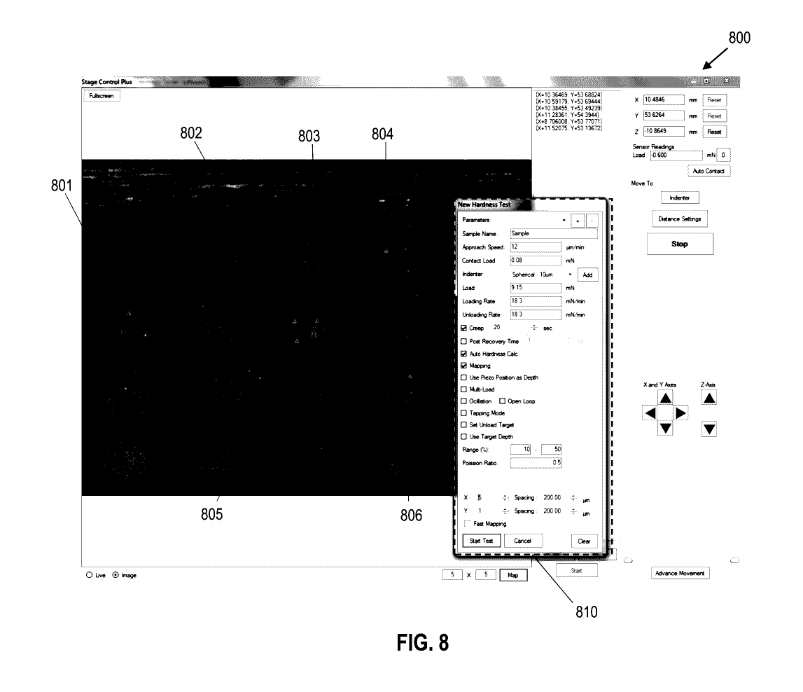

FIG. 8 is a screenshot of another embodiment of the display used in an apparatus for adjusting the field of view of a magnified sample and shows multiple selected test start position on a mapped image. As shown in FIG. 8, another embodiment of the display of the test window 800 used in an apparatus for adjusting the field of view may comprise test locations and new test parameters window 810. FIG. 8 shows that, while the mapped image of the sample is displayed on the test window 800, the user may select portions of the test sample for testing. Specifically, the user may use the interface device (e.g., mouse cursor, joystick) to find and then select test locations 801, 802, 803, 804, 805, 806 and may then set those test locations 801, 802, 803, 804, 805, 806 as new areas for material testing. In various embodiments, the user may open a new test parameter window 810 so that the user may also apply various testing parameters for each test location 801, 802, 803, 804, 805, 806.

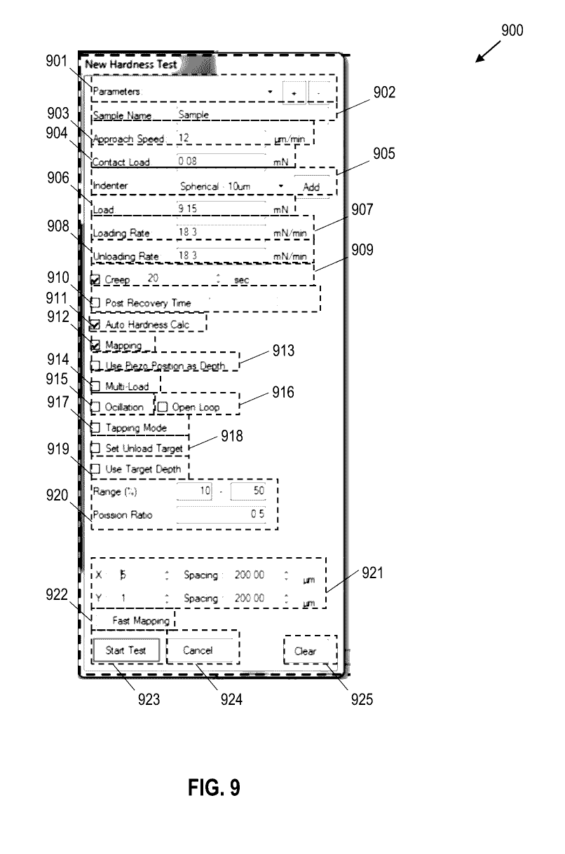

FIG. 9 is a close up of a screenshot of one embodiment of the test window for inputting test parameters. As shown in FIG. 9, one embodiment of the test window 900 may comprise: a parameters field 901, sample name input field 902, approach speed input field 903, contact load input field 904, indenter input field 905, applied load input field 906, loading rate input field 907, unloading rate input field 908, creep field 909, post recovery time parameter 910, auto hardness calculation parameter 911, mapping parameter 912, piezoelectric element parameter 913, multi-load parameter 914, oscillation parameter 915, open loop parameter 916, tapping mode parameter 917, set unload target parameter 918, target depth parameter 919, range and Poisson rate parameter 920, position and distribution parameter 921, fast mapping parameter 922, start button 923, cancel button 924, and clear button 925.

The parameters field 901 may be configured to populate preselected parameters for each material test. The sample input field 902 may allow the user to name the type of material that is to be tested. The approach speed input field 903 may allow the user to input an initial speed of the indenter towards the sample and may be expressed as speed as a function of time (e.g., μm/min). The contact load input field 904 may allow the user to select the amount of force (e.g., mN) the indenter is to be applied to the surface of the sample. The indenter input field 905 may allow the user to select a certain type of indenter to be used for each material test. The applied load input field 906 may be configured to select the amount of load applied to the sample. The loading rate input field 907 and unloading rate input field 908 may allow the user to adjust the loading rate and unloading rate of each material test. The creep field 909 may allow the user to apply a constant force (e.g., maximum applied force) towards the sample while measuring the change of indentation with that constant test force applied. The post recovery time parameter 910 allows the user to select the recovery time until contact with the probe reoccurs. The auto hardness calculation parameter 911 may allow the user to automatically calculate various hardness parameters such as Vickers (HV), Rockwell (HRC), and Martens hardness (HB). The mapping parameter 912 may allow the user to perform a plurality of uniform indentations distributed across a sample area to assess the variation of mechanical properties across that surface area. The piezoelectric element parameter 913 may allow the user to select the piezoelectric member to assess the penetration depth of the indenter. The multi-load parameter 914 allows the user to select multiple indentations with varying maximum load parameters for each indentation. The oscillation parameter 915 may allow the user to create an oscillation or applied harmonic force of the indenter upon the sample. The open loop parameter 916 may allow the user to perform the indentation test based on a pre-selected level of force (rather than maintaining a desired force based on the feedback from the force transducer or load sensor). The tapping mode parameter 917 may allow the user to create intermittent contact between the indenter and sample. The set unload target parameter 918 may allow the user to configure the amount of load applied to the sample during the unloading phase. The target depth parameter 919 allows the user to configure the penetration depth of the indenter to the sample. The range and Poisson rate parameter 920 may allow the user to create a Poisson distribution k of indentations at a given time or range. The position and distribution parameter 921 may allow the user to configure the amount of distribution, space, and/or intervals when mapping each indentation. The fast mapping parameter 922 may allow the user to perform the mapping process at a faster rate. The start button 923 may be selected to begin the test for each test position, and the cancel button 924 may be selected to cancel the desired tests. The clear button 925 may be selected to clear one or more parameters shown in the test window 900.

FIG. 10 is a screenshot of another embodiment of the display used in an apparatus for adjusting the field of view of a magnified sample and shows stage movement settings relating to the advanced movement button. As shown in FIG. 10, another embodiment of the display of the test window 1000 used in an apparatus for adjusting the field of view may comprise: stage positioning buttons 1010, absolute stage position buttons 1020, and speed bar 1030. After selecting the advance movement button 730, additional features for stage movement may be visible to the user. For example, the stage positioning buttons 100 may allow the user to precisely move the stage in the x, y, or z direction by incremental steps. The absolute stage position buttons 1020 may allow the user to move the stage at its absolute position. The speed bar 1030 may allow the user to adjust the speed of the stage movement.

The foregoing description of the preferred embodiment has been presented for the purposes of illustration and description. While multiple embodiments are disclosed, still other embodiments will become apparent to those skilled in the art from the above detailed description, which shows and describes the illustrative embodiments. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A camera enabled navigation system for a material testing apparatus, comprising:
a camera;
a movable stage;
a display;
an interface device;
a processor; and
a data storage;
wherein said movable stage is configured to receive a sample;
wherein said camera comprises one or more lenses that are positioned approximately above said sample, such that said camera is configured to capture one or more images of said sample;
wherein said processor is coupled to said camera and is operatively associated with said data storage, such that said processor is adapted to execute computer implemented instructions to:
display on said display said one or more captured images transmitted from said camera;
calculate one or more dimensions of a field of view that is displayed on said display;
pre-store said one or more captured images into said data storage;
receive one or more selected points of said displayed one or more captured images from said interface device based on one or more inputs of a user;
record one or more coordinates based on said one or more selected points of said interface device;
wherein said one or more coordinates are based on a distance from a center of said field of view to said one or selected points;
calculate an image speed percentage based on said one or more coordinates;
calculate a stage speed based on said one or more dimensions of said field of view; and
actuate one or more motors of said movable stage based on said image speed percentage and said stage speed, such that a speed of an image movement is proportional to a distance between said one or more selected positions and said center of said field of view.

2. The camera enabled navigation system of claim 1, wherein said image speed percentage of said one or more coordinates is also calculated based on one or more dimensions of said image.

3. The camera enabled navigation system of claim 1, wherein said calculating function of said one or more dimensions of said field of view is based on a zoom range of said one or more camera lenses.

4. The camera enabled navigation system of claim 1, wherein said processor is configured to create a mapping based on a plurality of mapping images by:
calculating a second field of view based on said plurality of mapping images;
recording one or more second coordinates of said plurality of mapping images; and
calculating a plurality of stage positions based on said plurality of second coordinates, such that each of said plurality of stage positions corresponds with each of said plurality of mapping images.

5. The camera enabled navigation system of claim 4, wherein said plurality of stage positions are calculated based on one or more dimensions of said plurality of mapping images.

6. The camera enabled navigation system of claim 4, wherein said plurality of stage positions are calculated based on one or more offsets from a center of said second field of view.

7. The camera enabled navigation system of claim 4, wherein said processor is further adapted to execute computer implemented instructions to limit an image size for each of said plurality of mapping images.

8. The camera enabled navigation system of claim 1, further comprising a sensor head;
wherein said sensor head determines a reference point within said field of view; and
wherein said processor is further adapted to calculate an offset between said sensor head and said camera lens, such that said processor is adapted to calculate a position required to actuate said movable stage to said sensor head.

9. The camera enabled navigation system of claim 1, wherein said processor is a computer system electrically coupled to a material testing apparatus; and
wherein said computer system is configured to execute said computer implemented instructions, such that said computer system actuates said movement of said movable stage.

10. The camera enabled navigation system of claim 1, wherein said interface device is selected from the group of interface devices consisting of: a mouse and a touchscreen.

11. A camera enabled navigation system for a material testing apparatus, comprising:
a camera;
a movable stage;
a display;
an interface device;
a processor; and
a data storage;
wherein said movable stage is configured to receive a sample;
wherein said camera comprises one or more lenses that are positioned approximately above said sample, such that said camera is configured to capture one or more images of said sample;
wherein said processor is coupled to said camera and is operatively associated with said data storage, such that said processor is adapted to execute computer implemented instructions to:
display on said display said one or more images transmitted from said camera;
capture said one or more images transmitted from said camera to said display, such that a field of view is displayed on said display;
calculate one or more dimensions of said field of view that is displayed on said display;
position a cursor of said interface device on said one or more displayed images;
receive one or more selected points of said one or more displayed images from said interface device based on one or more positions of said cursor;
record one or more coordinates based on said one or more selected points of said interface device;
wherein said one or more coordinates is based on a distance from a center of said field of view to said one or selected points;
calculate an image speed percentage based on said one or more coordinates;
wherein said image speed percentage of said one or more coordinates is also calculated based on one or more dimensions of said one or more images;
calculate a stage speed based on said one or more dimensions of said field of view;
actuate one or more motors of said movable stage based on said image speed percentage and said stage speed, such that a speed of an image movement is proportional to a distance between said cursor and said center of said field of view.

12. The camera enabled navigation system of claim 11, wherein said calculating function of said one or more dimensions of said field of view is based on a zoom range of said one or more camera lenses.

13. The camera enabled navigation system of claim 11, wherein said processor is adapted to create a mapping based on a plurality of mapped images by:
calculating a second field of view based on said plurality of mapped images;
recording one or more second coordinates of said plurality of mapped images; and
calculating a plurality of stage positions based on said plurality of second coordinates, such that each of said plurality of stage positions corresponds with each of said plurality of mapped images.

14. The camera enabled navigation system of claim 14, wherein said plurality of stage positions is also calculated based on one or more dimensions of said plurality of mapped images.

15. The camera enabled navigation system of claim 14, wherein said plurality of stage positions is also calculated based on an offset from a center of said second field of view.

16. The camera enabled navigation system of claim 14, wherein said processor is further adapted to execute computer implemented instructions to limit an image size for each of said plurality of mapped images.

17. The camera enabled navigation system of claim 11, further comprising a sensor head;
wherein said sensor head determines a reference point within said field of view; and
wherein said processor is further adapted to:
calculate an offset between said sensor head and said one or more camera lenses, such that said processor is adapted to calculate a position required to actuate said movable stage to said sensor head; and
positioning said one or more camera lenses from a center of said field of view to said sensor head.

18. The camera enabled navigation system of claim 11, wherein said processor is a computer system electrically coupled to a material testing apparatus; and
wherein said computer system is configured to execute said computer implemented instructions, such that said computer system actuates said movement of said movable stage.

19. A camera enabled navigation system for a material testing apparatus, comprising:
a camera;
a movable stage;
a display;
an interface device;
a processor;
a data storage; and
a sensor head;
wherein said movable stage is configured to receive a sample;
wherein said camera comprises one or more lenses that are positioned approximately above said sample, such that said camera is configured to capture an image of said sample;
wherein said processor is coupled to said camera and is operatively associated with said data storage, such that said processor is adapted to execute computer implemented instructions to:
display on said display said image transmitted from said camera;
capture said image transmitted from said camera to said display, such that a field of view is displayed;
calculate one or more dimensions of said field of view that is displayed on said display;
wherein said calculating function of said one or more dimensions of said field of view is based on a zoom range of said camera lens;
position a cursor of said interface device on said displayed image;
receive one or more selected points of said displayed image from said interface device based on one or more positions of said cursor;
record one or more coordinates based on said one or more selected points of said interface device;
wherein said one or more coordinates is based on a distance from a center of said field of view to said one or selected points;
calculate an image speed percentage based on said one or more coordinates;
wherein said image speed percentage of said one or more coordinates is also calculated based on one or more dimensions of said image;
calculate a stage speed based on said one or more dimensions of said field of view; and
actuate a motor of said movable stage based on said image speed percentage and said stage speed, such that a speed of an image movement is proportional to a distance between said cursor and said center of said field of view;
wherein said processor is adapted to create a mapping based on a plurality of mapped images by:
calculating a second field of view based on said plurality of mapped images;
limiting an image size for each of said plurality of mapped images;
recording one or more second coordinates of said plurality of mapped images; and
calculating a plurality of stage positions based on said plurality of second coordinates, one or more dimensions of said plurality of mapped images, and one or more offsets from a center of said second field of view, such that each of said plurality of stage positions corresponds with each of said plurality of mapped images;
wherein said sensor head determines a reference point within said field of view; and
wherein said processor is further adapted to:
calculate an offset between said sensor head and said camera lens, such that said processor is adapted to calculate a position required to actuate said movable stage to said sensor head; and
position said camera lens from a center of said field of view to said sensor head.
